(19) United States
(12) Patent Application Publication
(10) Pub. No.: US 2018/0110311 A1
(43) Pub. Date: Apr. 26, 2018

(54) SMART ANTI-LOST PORTABLE BAG

(71) Applicants: Jessey Lee, Frisco, TX (US); Hongbo Zhang, LaiFeng County (CN)

(72) Inventors: Jessey Lee, Frisco, TX (US); Hongbo Zhang, LaiFeng County (CN)

(21) Appl. No.: 15/788,759

(22) Filed: Oct. 19, 2017

(30) Foreign Application Priority Data
Oct. 21, 2016 (CN) 201621146214.0

(51) Int. Cl. A45C 13/18; A45C 3/06; A45C 1/06; A45C 15/00; G01S 19/16

(52) U.S. Cl. CPC A45C 13/185; A45C 3/06; H04W 4/008; A45C 15/00; G01S 19/16; A45C 1/06

(57) ABSTRACT

The present utility model provides a smart anti-lost portable bag, including a bag body. An interlayer is disposed in the bag body, a power module, a control module, a Bluetooth module, a charging module, a positioning module, and a remote communication module are disposed in the interlayer, the power module includes a lithium battery and a battery protection board that is wrapped around an external surface of the lithium battery, the power module is connected to the control module and the charging module, the control module is connected to the Bluetooth module, the positioning module, and the remote communication module, and the Bluetooth module and the remote communication module are connected to a mobile terminal. In the present utility model, an apparatus that is entirely configured to monitor the portable bag and upload data is disposed in the interlayer of the portable bag, and is sealed. Therefore, the battery can be prevented from being easily removed by a person after the portable bag is lost, or a monitoring apparatus can be prevented from being damaged when the portable bag is in good state, thereby reducing a probability that the monitoring apparatus is damaged after the portable bag is lost. In this way, a probability that the portable bag is found after the portable bag is lost or stolen is significantly increased, and use security is higher.

### BACKGROUND

### Technical Field

The present utility model relates to the field of portable bag technologies, and specifically, to a smart anti-lost portable bag.

### Related Art

In cities, about 90% of people use portable bags, for example, wallets, handbags, and backpacks, and even many children have wallets. However, people always put all important items in the portable bags and the wallets when they are out. Wallets are often lost or left out in life. Valuable items that are carried with people may be accidentally stolen. When wallets are stolen, people lose not only money but also many important documents, causing many troubles to people. After the wallets are lost, people suffer economic losses, and their lives are affected, bringing much inconvenience. It is often difficult for people to bear such losses. To resolve the problem of losing wallets or other portable bags, there are some portable bags that can implement a positioning function on the market, but for most of the portable bags, coin batteries are used to supply power. In this case, holes used for installing the batteries need to be provided on the portable bags. A battery is easily removed after a portable bag is picked up by a person. Consequently, the positioning function is lost.

The utility model with Application No. 201520444864.2 discloses an anti-theft wallet. The wallet includes a wallet body and an anti-theft apparatus. The anti-theft apparatus is located in an interlayer of the wallet body. The anti-theft apparatus includes a controller, a microbattery, and an alarm apparatus. A wrist strap is provided on an edge of the wallet body. The controller, the microbattery, and the alarm apparatus are connected to each other. In the present utility model, a microbattery is used. In this case, a component is necessary to be provided for battery replacement, causing serious potential troubles.

### SUMMARY

In view of this, the present utility model provides a smart anti-lost portable bag. An apparatus that is entirely configured to monitor the portable bag and upload data is disposed in an interlayer of the portable bag, and is sealed. Therefore, a battery can be prevented from being easily removed by a person after the portable bag is lost, or a monitoring apparatus can be prevented from being damaged when the portable bag is in good state.

To resolve the technical problem, the present utility model provides a smart anti-lost portable bag, including a bag body, where an interlayer is disposed in the bag body, a power module, a control module, a Bluetooth module, a charging module, a positioning module, and a remote communication module are disposed in the interlayer, the power module includes a lithium battery and a battery protection board that is wrapped around an external surface of the lithium battery, the power module is connected to the control module and the charging module, the control module is connected to the Bluetooth module, the positioning module, and the remote communication module, and the Bluetooth module and the remote communication module are connected to a mobile terminal.

Further, the control module includes a single-chip microcomputer, the positioning module includes a GPS module, and the remote communication module includes a GPRS module.

Further, the charging module includes a USB charging port that is connected to the lithium battery.

Further, the charging module includes a wireless charging receiver that is connected to the lithium battery.

Further, the charging module further includes a self-power mechanism that is fixedly disposed in the interlayer.

Further, the self-power mechanism includes a cavity, a piezoelectric ceramic rod is disposed in the cavity, a counter weight is disposed in the middle of the piezoelectric ceramic rod, and the piezoelectric ceramic rod is connected to the lithium battery.

Further, the cavity is ellipsoidal.

Beneficial effects of the technical solution in the present utility model are as follows: The present utility model provides a smart anti-lost portable bag. An apparatus that is entirely configured to monitor the portable bag and upload data is disposed in an interlayer of the portable bag, and is sealed. Therefore, a battery can be prevented from being easily removed by a person after the portable bag is lost, or a monitoring apparatus can be prevented from being damaged when the portable bag is in good state, thereby reducing a probability that the monitoring apparatus is damaged after the portable bag is lost. A charging module is connected to a power module, and charges the portable bag when an electric quantity is relatively low, preventing a replacement port from being reserved for replacing a battery, and avoiding a failure of the apparatus caused by removing a battery after the portable bag is lost. The power module is connected to a control module, to supply power to the control module and other modules connected to the control module, to implement a positioning reporting function. A Bluetooth module is connected to a mobile terminal, and may be bound in advance for making a short-range alarm. After the portable bag is beyond a Bluetooth communication range, a Bluetooth connection to the mobile terminal is disrupted and an alarm is made, to reduce a probability that the portable bag is lost. When the portable bag is stolen, the portable bag may be positioned by using a positioning module by means of communication between a remote communication module and the mobile terminal. Positioning data may be sent to the mobile terminal by using the remote communication module, so that the stolen portable bag may be easily found. The mobile terminal may be a terminal device such as a mobile phone or a computer, provided that data sent by the portable bag can be received.

In the present utility model, an apparatus that is entirely configured to monitor a portable bag and upload data is disposed in an interlayer of the portable bag, and is sealed. Therefore, a battery can be prevented from being easily removed by a person after the portable bag is lost, or a monitoring apparatus can be prevented from being damaged when the portable bag is in good state, thereby reducing a probability that the monitoring apparatus is damaged after the portable bag is lost. In this way, a probability that the portable bag is found after the portable bag is lost or stolen is significantly increased, a probability that the portable bag is lost is reduced, and use security is higher.

### BRIEF DESCRIPTION OF THE DRAWINGS

FIG. 1 is a schematic structural diagram of Embodiment 1 of a smart anti-lost portable bag according to the present utility model;

FIG. 2 is a schematic structural diagram of Embodiment 2 of a smart anti-lost portable bag according to the present utility model;

FIG. 3 is a schematic structural diagram of Embodiment 3 of a smart anti-lost portable bag according to the present utility model; and

FIG. 4 is a schematic structural diagram of a self-power mechanism according to the present utility model.

### DETAILED DESCRIPTION

To make objectives, technical solution, and advantages of embodiments of the present utility model clearer, the following clearly and completely describes the technical solution of the embodiments of the present utility model with reference to the accompanying drawings of the embodiments of the present utility model. Apparently, the described embodiments are some but not all of the embodiments of the present utility model. Based on the described embodiments of the present utility model, all other embodiments obtained by a person of ordinary skill in the art shall fall within the protection scope of the present utility model.

### Embodiment 1

As shown in FIG. 1, a smart anti-lost portable bag includes a bag 4. An interlayer 5 is disposed in the bag 4. A power module, a control module 6, a Bluetooth module 7, a charging module, a positioning module 8, and a remote communication module 9 are disposed in the interlayer 5. The power module includes a lithium battery 2 and a battery protection board 1 that is wrapped around an external surface of the lithium battery 2. The power module is connected to the control module 6 and the charging module. The control module 6 is connected to the Bluetooth module 7, the positioning module 8, and the remote communication module 9. The Bluetooth module 7 and the remote communication module 9 are connected to a mobile terminal. The control module 6 includes a single-chip microcomputer, the positioning module 8 includes a GPS module, and the remote communication module 9 includes a GPRS module. The charging module includes a USB charging port 3 that is connected to the lithium battery 2.

An apparatus that is entirely configured to monitor the portable bag and upload data is disposed in an interlayer of the portable bag, and is sealed. Therefore, a battery can be prevented from being easily removed by a person after the portable bag is lost, or a monitoring apparatus can be prevented from being damaged when the portable bag is in good state, thereby reducing a probability that the monitoring apparatus is damaged after the portable bag is lost. A charging module is connected to a power module, and charges the portable bag when an electric quantity is relatively low, preventing a replacement port from being reserved for replacing a battery, and avoiding a failure of the apparatus caused by removing a battery after a portable bag is lost. The power module is connected to a control module, to supply power to the control module and other modules connected to the control module, to implement a positioning reporting function. A Bluetooth module is connected to a mobile terminal, and may be bound in advance for making a short-range alarm. After the portable bag is beyond a Bluetooth communication range, a Bluetooth connection to the mobile terminal is disrupted and an alarm is made, to reduce a probability that the portable bag is lost. When the portable bag is stolen, the portable bag may be positioned by using a positioning module by means of communication between a remote communication module and the mobile terminal. Positioning data may be sent to the mobile terminal by using the remote communication module, so that the stolen portable bag may be easily found. The mobile terminal may be a terminal device such as a mobile phone or a computer, provided that data sent by the portable bag can be received. In this embodiment, the charging module uses a USB charging port for charging. The charging port is disposed on a surface of the portable bag, provided that a charging function is implemented. The battery is sealed for protection, to avoid positioning and monitoring failures caused by removal of the battery.

### Embodiment 2

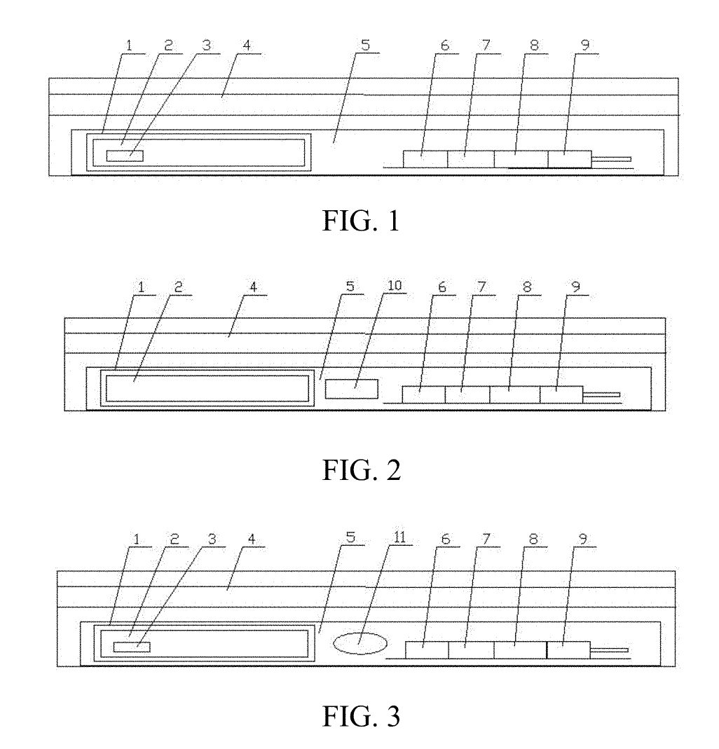

As shown in FIG. 2, a difference between Embodiment 2 and Embodiment 1 is that the charging module includes a wireless charging receiver 10 that is connected to the lithium battery 2. This embodiment provides another implementation of the charging module. The portable bag is wirelessly charged by disposing the wireless charging receiver. According to this implementation, an entire aesthetic degree of the portable bag may be improved.

### Embodiment 3

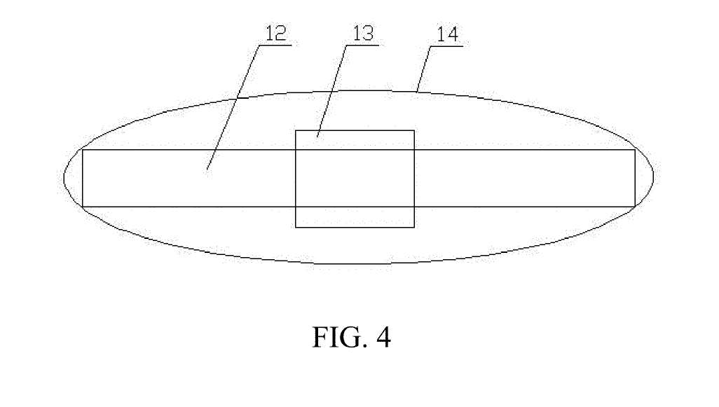

As shown in FIG. 3 and FIG. 4, a difference between Embodiment 3 and Embodiment 1 is that the charging module further includes a self-power mechanism 11 that is fixedly disposed in the interlayer 5. The self-power mechanism 11 includes a cavity 14, a piezoelectric ceramic rod 12 is disposed in the cavity 14, a counter weight 13 is disposed in the middle of the piezoelectric ceramic rod 12, and the piezoelectric ceramic rod 12 is connected to the lithium battery 2. The cavity 14 is ellipsoidal. In this embodiment, the self-power mechanism is added based on Embodiment 1. When the portable bag is stolen and an electric quantity of the lithium battery is low, the self-power mechanism is used for power generation, to ensure that the positioning module can implement positioning and send data to the mobile terminal. The self-power mechanism uses vibration power generation. The piezoelectric ceramic rod is fixed in the cavity. When a person holds the portable bag in hand and walks, the piezoelectric ceramic rod can vibrate and twist due to a function of the counter weight, to generate electric energy and charge the lithium battery, thereby further increasing a probability that the portable bag is found.

According to the method of the present utility model, a power module is charged by using a charging module, the power module supplies power to a control module and other modules, and a Bluetooth module is bound to a mobile terminal. When a distance between a portable bag and an owner is greater than a specified distance, a Bluetooth connection to the mobile terminal is disrupted and an alarm is made. When the portable bag is stolen, that is, when the portable bag is far away from the owner of the portable bag, a remote communication module sends, to the mobile terminal, positioning information that is obtained by means of detection by a positioning module, so that the portable bag is easy to find. When the portable bag is lost and an electric quantity of the power module is low, a self-power mechanism generates power by using vibration energy generated when the theft walks, to meet requirements for positioning and data transmission, and increase a probability that the portable bag is found.

The above descriptions are preferred implementations of the present utility model. It should be noted that, portable bags include but are not limited to common types of bags such as wallets, handbags, backpacks, and briefcases. A person of ordinary skill in the art may make several improvements and modifications without departing from the principle of the present utility model, and the improvements and modifications shall also fall within the protection scope of the present utility model.

What is claimed is:

1. A smart anti-lost portable bag, comprising a bag body, wherein an interlayer is disposed in the bag body, a power module, a control module, a Bluetooth module, a charging module, a positioning module, and a remote communication module are disposed in the interlayer, the power module comprises a lithium battery and a battery protection board that is wrapped around an external surface of the lithium battery, the power module is connected to the control module and the charging module, the control module is connected to the Bluetooth module, the positioning module, and the remote communication module, and the Bluetooth module and the remote communication module are connected to a mobile terminal.

2. The smart anti-lost portable bag according to claim 1, wherein the control module comprises a single-chip microcomputer, the positioning module comprises a GPS module, and the remote communication module comprises a GPRS module.

3. The smart anti-lost portable bag according to claim 1, wherein the charging module comprises a USB charging port that is connected to the lithium battery.

4. The smart anti-lost portable bag according to claim 1, wherein the charging module comprises a wireless charging receiver that is connected to the lithium battery.

5. The smart anti-lost portable bag according to claim 3, wherein the charging module further comprises a self-power mechanism that is fixedly disposed in the interlayer.

6. The smart anti-lost portable bag according to claim 5, wherein the self-power mechanism comprises a cavity, a piezoelectric ceramic rod is disposed in the cavity, a counter weight is disposed in the middle of the piezoelectric ceramic rod, and the piezoelectric ceramic rod is connected to the lithium battery.

7. The smart anti-lost portable bag according to claim 6, wherein the cavity is ellipsoidal.

8. The smart anti-lost portable bag according to claim 4, wherein the charging module further comprises a self-power mechanism that is fixedly disposed in the interlayer.
